(19) United States
(12) Patent Application Publication
(10) Pub. No.: US 2025/0208912 A1
(43) Pub. Date: Jun. 26, 2025

(54) Live Interval Analysis

(71) Applicant: Ab Initio Technology LLC, Lexington, MA (US)

(72) Inventor: Iain Bason, Winchester, MA (US)

(21) Appl. No.: 18/746,432

(22) Filed: Jun. 18, 2024

Related U.S. Application Data
(60) Provisional application No. 63/613,813, filed on Dec. 22, 2023.

(51) Int. Cl. G06F 9/50

(52) U.S. Cl. CPC G06F 9/5016

(57) ABSTRACT

An approach to allocation of referenced objects to memory resources addresses a situation in which there are a far greater number of memory resources, for example, 2¹⁶ elements in the set of memory resources, and yet the objects referenced in a program specification exceeds this number. The approach is applicable to compilation of a program specification for execution on a physical or virtual processor.

### CROSS-REFERENCE TO RELATED APPLICATIONS

This application claims the benefit of U.S. Provisional Application No. 63/613,813, filed on Dec. 22, 2023, which is incorporated herein by reference.

### in BACKGROUND OF THE INVENTION

This invention relates to execution of computer program specifications, and more particularly to allocation of limited memory resources to objects referenced in such specifications.

A technical problem in execution of computer program specifications includes allocating objects referenced in the program specification for example, by variables names in a substantially open-ended set of character strings, to a limited set of memory resources. Generally, a program specification may have a larger number of referenced objects than can be uniquely associated with memory resources, and during execution at least some memory resources must be shared such that a particular memory resource may be associated with a first referenced object during one set of time intervals of execution of the program, and be associated with a second referenced object during a second disjoint (i.e., non-overlapping) set of time intervals.

A specific instance of this problem is in case of the memory resources being processor registers, and the object references in the program specification are variables in a high-level programming language. For example, a processor may have 32 registers, and thousands of variables. Therefore, a number of register allocation algorithms address the temporary allocation of variables to registers, potentially “spilling” values of variables from registers to slower memory, and later reloading the values to registers when they are needed for further computation.

### SUMMARY OF THE INVENTION

In a general aspect, an approach to allocation of objects references in a program specification, such as distinct named variables, to memory resources addresses a situation in which there are a far greater number of memory resources, for example, 2¹⁶ elements in the set of memory resources, and yet the objects referenced in the program specification exceeds this number. While some register allocation approaches may be applied to this situation, the scale of this allocation problem can result in unacceptable inefficiency.

In one aspect, in general, a method for executing a program specification on a processor includes allocating a first set of distinct variables in a representation of the program specification to a second set of memory locations accessible by the processor. The size of the second set is smaller than the size of the first set, and the size of the second set is limited by a memory characteristic of the processor. The representation of the program specification includes a graph representation in which nodes of the graph comprise instructions referencing the variables, and directed links (i.e., if a node X has a directed link to node Y, then Y is a “successor” or X, and X is “predecessor” of Y) in the graph represent allowable directed paths of control flow during execution of the program specification. The method includes determining a numbered ordering of the nodes of the graph representation, such that each node has a unique number, and identifying all loops represented in the graph such that each loop has a set of nodes, and an interval of the lowest to the highest number assigned to any node in the set of nodes in the loop. A live interval is determined for each (or at least some) distinct variable in the representation of the program specification, including determining a live interval for a first variable of the distinct variables. This determining of the live interval for the first variable includes (e.g., at STEP 2A of PROCEDURE 1) determining a first subset of nodes in the graph representation that include an instruction referencing the first variable, including determining a second subset of nodes in which the instruction fully assigns the first variable (e.g., referred to herein as set of “killing references” denoted “K”) and a third subset of nodes consisting of the nodes in the first set of nodes that are not in the second set of nodes (e.g., referred to herein as a set of “other references” denoted “R”). An initial live interval for the first variable is determined as the interval from the lowest numbered node to the highest numbered node in the first subset of nodes (e.g., STEP 2B of PROCEDURE 1). An expanded live interval for the first variable is determined according to one or more loops represented in the graph, including expanding the live interval for the first variable according to a first loop represented in the graph (e.g., STEP 2C of PROCEDURE 1). This expanding according to the first loop includes first determining an interval of the loop as the interval from the lowest numbered node of the loop to the highest numbered node of the loop, the loop having a header node being a first node of the loop accessed during execution of the program specification. Next, (e.g., at STEP 2Cii of PROCEDURE 1) it is determined if there is any node in the third subset of nodes for which there is at least one path of execution from the header node of the loop that does not pass through a node in the second subset of nodes. Having determined that there is such a node in the third subset of nodes, the live interval of the first variable is expanded to include the full interval of nodes of the first loop. The method further includes allocating variables to distinct memory items accessible by the processor, including allocating multiple variables to a same memory item according to the live intervals for said multiple variables. A second representation of the program specification is formed using a result of allocating the variables. The second program specification may be executed using the processor, including accessing the memory items during execution according to the allocation of variables to the memory items.

Aspects may include one or more of the following.

The processor comprises a virtual processor executing on a physical processor.

The second set of memory locations accessible by the processor comprises a data structure accessible to the physical processor with a distinct storage item accessible by the virtual processor for each memory location.

Execution of a first instruction of the second program by the virtual processor comprises the physical processor accessing a storage item in the data structure corresponding to a memory location in a field of the first instruction.

The size of the second set exceeds 1024 memory locations, or exceeds 16384 memory locations.

Determining if there is any node in the third subset of nodes for which there is at least one path of execution from the header node of the loop that does not pass through a node in the second subset of nodes comprises determining that there is such a node that can be reached only via the header node.

Determining if there is any node in the third subset of nodes for which there is at least one path of execution from the header node of the loop that does not pass through a node in the second subset of nodes comprises determining that there is no such a node that can be reached only via the header node, forming a fourth subset of nodes that is distinct from the third subset of nodes and that can be reached in an execution path from the header node without passing through a node of the second subset and can further be reached in an execution path without passing through the header node (e.g., STEP 4B of PROCEDURE 2, with the fourth set comprising the blocks F of the dominance frontier), and determining if there is any node in the third subset of nodes for which there is at least one path of execution from a node in the fourth subset that does not pass through a node in the second subset of nodes (e.g., recursively performing PROCEDURE 2).

In another aspect, in general, a method forms part of a process used for executing a program specification on a processor (1240). For instance, this method may be used when the program specification is executed in a “just-in-time” compilation triggered by execution of the program specification, or may be uses as part of a preparatory compilation process that forms an executable representation of the program specification, for instance as an intermediate stage of a multiple-stage compilation process.

The method includes allocating a first set of distinct variables in a representation of the program specification (110) to a second set of memory item (1220) accessible by the processor. The number of memory items in the second set is smaller than the size of number of distinct variables in the first set, and the number of memory items in the second set is limited by a memory characteristic of the processor.

The representation of the program specification comprises a graph (124) in which nodes of the graph comprise specify instructions referencing the variables, and directed links coupling nodes of the graph represent allowable paths of control flow during execution of the program specification. For instance, the program specification may be the product of a prior compilation or program generation stage.

The method includes determining an enumerated ordering of the nodes of the graph representation, such that each node is assigned a unique number (i.e., an identifier that can be ordered such that in a set of such identifiers there is a first or lowest one and a last or highest one).

All (or at least some of) the loops represented in the graph are identified. Each loop has a set of nodes that are linked as part of a cycle by directed links of the graph. Each loop has an interval of the lowest to the highest number assigned to the nodes in the set of nodes in the each loop.

A live interval for each distinct variable in the representation of the program specification, is determined using a procedure that includes the following steps when applied to a first variable.
(a) A first subset of nodes in the graph representation is determined such that each node in the first subset specifies an instruction referencing the first variable.
(b) A second subset of nodes is determined such that each node in the second subset specifies an instruction that fully assigns the first variable. This second set is a subset of the first set.
(c) A third subset of nodes is determined to consist of the nodes in the first set of nodes that are not in the second set of nodes.
(d) A live interval for the first variable is initialized as an interval from the lowest numbered node to the highest numbered node in the first subset of nodes.
(e) The live interval for the first variable is expanded (i.e., the set is augmented to include nodes not already in the live interval) according to one or more loops represented in the graph. The expanding the live interval for the first variable according to a first loop represented in the graph includes the following steps.
   (i) An interval of the first loop is determined as the interval from the lowest numbered node of the loop to the highest numbered node of the loop. The first loop has a header node that is the first node of the loop is accessed during execution of the program specification.
   (ii) It is determined if there is any node in the third subset of nodes for which there is at least one path of execution from the header node of the loop to that node that does not pass through a node in the second subset of nodes.
   (iii) Having determined that there is such a node in the third subset of nodes, the live interval of the first variable is expanded to include the full interval of nodes of the first loop.

Variables of the first set of distinct variables are allocated to memory items of the second set of memory items, including by allocating multiple of said variables to a same memory item according to the live intervals for said multiple variables.

A second representation (130; 1210) of the program specification is formed using a result of allocating the variables.

The method can include one or more of the following features.

The second representation of the program specification is executed using the processor.

Execution of the second representation of the program specification includes accessing the memory items during execution according to the allocation of variables to the memory items.

Determining the enumerated ordering of the nodes of the graph representation includes forming a depth-first ordering based on the directed links coupling of the nodes of the graph.

The program specification is formed from an initial program specification that comprises a graph-based program specification.

The processor comprises a virtual processor executing on a physical processor.

The second set of memory items accessible by the processor comprises a data structure (1220) accessible to the physical processor with a distinct storage item (1222) accessible by the virtual processor for each memory location.

Execution of a first instruction (1212) of the second representation of the program specification by the virtual processor comprises the physical processor accessing a storage item in the data structure corresponding to a memory location in a field of the first instruction.

At least some of the distinct storage items include references to data storage areas (1232) accessible to the physical processor outside the data structure.

The number of memory items in the second set exceeds 1023 memory items.

The number of memory items in the second set exceeds 16383 memory items.

Determining if there is any node in the third subset of nodes for which there is at least one path of execution from the header node of the first loop that does not pass through a node in the second subset of nodes comprises determining that there is such a node that can be reached only via the header node.

Determining if there is any node in the third subset of nodes for which there is at least one path of execution from the header node of the loop that does not pass through a node in the second subset of nodes comprises
(a) determining that there is no such a node that can be reached only via the header node,
(b) forming a fourth subset of nodes that is distinct from the third subset of nodes and that can be reached in an execution path from the header node without passing through a node of the second subset and can further be reached in an execution path without passing through the header node, and
(c) determining if there is any node in the third subset of nodes for which there is at least one path of execution from a node in the fourth subset that does not pass through a node in the second subset of nodes.

In another aspect, in general, a procedure for determining the live intervals for variables referenced in the blocks of an intermediate representation includes the following:
Step 1: Order the instructions the intermediate representation in reverse post-order depth first. Number the instructions in each block to ensure that the last instruction in block B will have a lower number than the first instructions in any of B's successors, unless the successor is reached via a backwards edge (i.e., a transition back to a header node of a loop). Also identify all the loops in the intermediate representation, and their associated intervals according to the number of the instructions.
Step 2: The following steps 2A-2C are performed for each variable V:
   Step 2A: Collect a set of killing definitions (K) and other references (R) for the variable (V), each ordered by the instruction number.
   Step 2B: Determine an initial live interval for V as the interval from the first to the last member of either K or R.
   Step 2C: For each loop L in the intermediate representation perform the following two substeps:
      Step 2Ci: If L is contained entirely within V's interval, or if L contains no part of V's interval, ignore the loop L.
      Step 2Cii: Otherwise, check whether any member of R (whether in the loop or not) is upwardly exposed to the first instruction of L's header. If it is, expand V's interval to include all of L.

In another aspect, in general, a recursive procedure is used to determine whether there is any other reference in R for a particular loop L and variable V by considering successive dominance frontiers until a reference in R is found that is upwardly exposed to the header of L, or it is certain that no such reference in R exists, in which case the interval of L does not have to be added to the live interval of V. This procedure may be defined in terms of arguments V and I, such that the procedure is started with I being the loop header of L and with static sets R and K for the variable V being accessible to the procedure. The procedure includes the following steps:
Step 1: Of the killing definitions of variable V, denoted K, determine a subset denoted K_{D} as consisting of the members of K that are dominated by I. That is, for any block k in K_{D}, all paths from the entry block to k go through I.
Step 2: Expand K_{D} to iteratively include the first instruction of any basic block B that is dominated by I, and not dominated by any member of K_{D}, but all of whose predecessors are dominated by members of K_{D}.
Step 3: Determine the members of the other references, denoted R, of variable V that are dominated by I, and not dominated by a member of K_{D}.
Step 4: If there is any such member of R in step 3,
Step 4A: then: there is a block that is upwardly exposed to I, and in turn is also upwardly exposed to the loop header (see STEP 2Cii above) and the interval of the loop is added to the live interval of variable V, and all further search of R can be terminated;
Step 4B: otherwise: for each block F in the dominance frontier of I (domf(I)) with an incoming link from a block that is dominated by I and not dominated by any member of K_{D}, perform Procedure2(F, V). That is, the point of this recursive call is to determine if there is a path from I to any member of R that is not dominated by I.

An advantage of one or more aspects is that fewer distinct memory items are needed for allocation of the distinct variables used in a representation of a program specification. As a consequence, the allocated distinct variables may be accommodated in a memory system of a processor that does not have capacity to allocate each variable to a different memory item. For example, the number of memory items may be limited by the number of address bits allocated to identify a memory item in a processor instruction. Without application of such a procedure that reduces the number of distinct memory items needed for all the distinct variables, execution of the program specification on such a processor could fail because the memory capacity could be exceeded.

Another advantage of one or more embodiments is that the procedures used to allocate variables to memory locations is particularly effective (e.g., computationally efficient) in a tradeoff of execution time required to determine the memory allocation as compared to the ultimate number of memory items required for execution of the program specification. In particular, the procedures can be substantially faster that previous approaches used for register allocation, which are targeted to orders of magnitude fewer target memory locations (e.g., 10 s of registers versus 10 s or 100 s of thousands of memory items that may be allocated using the presented procedures. These procedures execute rapidly enough to be applicable as part of “just-in-time” compilation of program specifications, for example, as an intermediate stage of a multiple-stage compilation process.

Other features and advantages of the invention are apparent from the following description, and from the claims.

### BRIEF DESCRIPTION OF THE DRAWINGS

FIG. 1 is a schematic diagram of compilation and execution of a program specification;

FIGS. 2-10 are exemplary parts of control flow graphs determined from program specifications;

FIG. 11 is an initial control flow graph and a corresponding expanded control flow graph;

FIG. 12 is a diagram of a memory arrangement for a data processing system; and

FIG. 13 is a diagram of parts of a data processing system.

### DETAILED DESCRIPTION

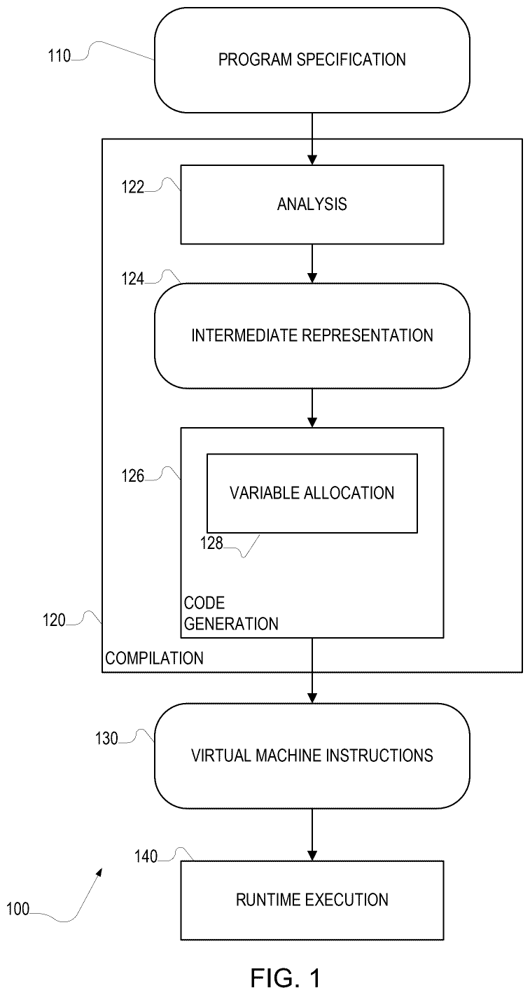

Referring to FIG. 1, a process 100 for execution of a program specification 110 involves compilation 120 of the program specification. In this example, the target of the compilation is a virtual machine (e.g., a “bytecode interpreter”), so the output of compilation are virtual machine instructions 130 (e.g., “bytecodes” or “bytecode instructions”). These instructions are provided to a processor, in this example a virtual machine, for runtime execution 140. For instance, the virtual machine is a software-implemented process that executes in a lower-level environment (e.g., on a physical processor under the control of an operating system) and provides access to computing resources such as memory (storage) resources. The compilation process may be performed well prior to execution, for instance at “development” time. In other examples, the compilation may be performed “just in time” in response to initiation of execution of the program specification.

The program specification in the present example uses a high-level programming language specified in text form. The specification may be authored by a programmer, but may equivalently be generated by a program generator, for example, from another form of program (e.g., in a visual and/or graph-based programming environment) or some other problem or program specification.

For the sake of discussion, compilation 120 is shown as comprising an analysis 122 of the program specification forming an intermediate representation 124 of the program. The compilation then comprises code generation 126 that translates the intermediate representation 124 into the virtual machine instructions 130, which are then used for the runtime execution 140. Generally, the analysis 122 performs lexical, syntactic and/or semantic analysis of the program specification 110, and represents the program language statements of that program specification in a form that is amenable for further compilation steps leading up to the generation of the machine instructions.

One feature of the intermediate representation 124 is that there is essentially no limit on the number of variables that are referenced, for instance with the intermediate representation including all the variables referenced in the program specification, and typically even more variables representing, for example, results of intermediate computations or common subexpressions, or variables related to the structure of the intermediate representation. For example, variables in the program specification may be specified by text strings (i.e., as variable names), and therefore even with a length limit, there is a combinatorically large number of distinct variable names that may be expressed in the program specification.

An aspect of the virtual machine instructions 130 is that data items are referenced by a fixed set of data item indices, and the virtual machine instructions specify data items according to their indices. For example, for a virtual machine that permits a set of 2^{k} data items to be referenced with distinct indices (e.g., “addresses”) as an operand in an instruction, the virtual machine instruction format may reserve K bits for such an operand (e.g., K=10, 11, . . . , or 16 bits). For example, such instructions may have an operation code (“opcode”) and a fixed number (e.g., 5) of operands, each with K bits reserved for it. Note that in this example, the data items themselves may be complex structures or multi-element arrays, and generally correspond to variable names in the program specification 110—that is, the number of data items that can be handled (i.e., referenced as operands using respective indices) by the virtual machine is not the same as the memory size needed to store all those data items.

Turning back to the code generation 126, which processes the intermediate representation 124 to form the virtual machine instructions, one aspect of that code generation 126 is the allocation (i.e., many-to-one mapping) of distinct variables in the program specification to particular data item indices using a variable allocation process 128 for use in the virtual machine instructions 130. It should be recognized that at least some variables are not needed throughout the execution of the program, and therefore one particular data item index may be reused for many different variables in different parts of the program.

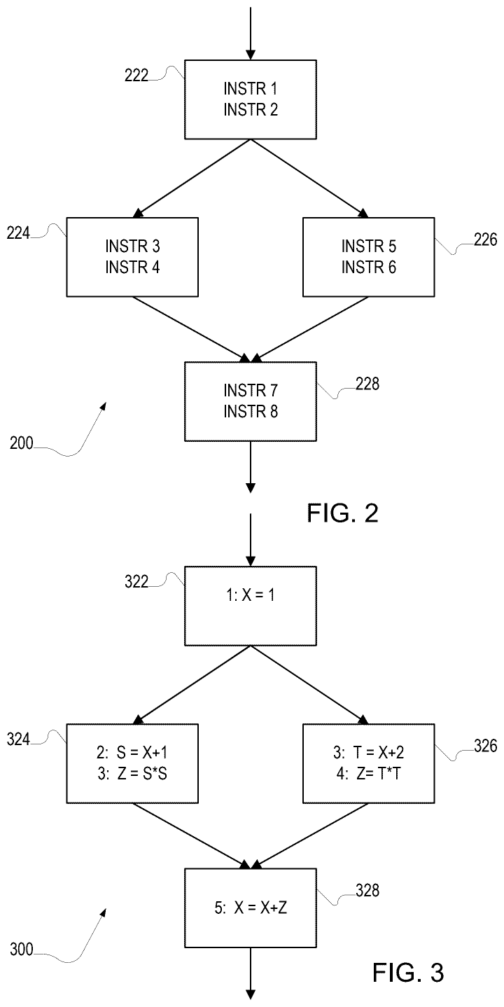

Referring to FIG. 2, very generally, the intermediate representation 124 has the form of a directed graph, where each node (222-228) in an exemplary graph 200 may have a number of instructions in it such that the instructions are always executed in order without any branches into or out of the sequence imposed by the graph. Such a node may also be referred to as a “block”, “basic block”, or an “instruction block” and the graph may be referred to as a “control flow graph (CFG)”. The execution paths (also referred to as paths) through the graph therefore determine the possible sequences of instructions. For example, in this example, the sequences INSTR 1, 2, 3, 4, 7, 8 and INSTR 1, 2, 5, 6, 7, 8 are possible. To the extent that instructions set or update (i.e., write at least some of the referenced data structure) values into variables and/or use (i.e., read) values from variables, this graph representation may be used to determine a feasible allocation of variables to the limited set of data item indices.

In certain procedures described below, it is useful to order the blocks, for example, in the illustration of FIG. 2, the blocks may be ordered as blocks 222, 224, 226, and then 228. For example, they may be ordered according to a depth-first ordering (i.e., the reverse of the order in which nodes are visited in a postorder traversal of the flow graph) of the blocks and sequential ordering of the instructions in each block. In such an ordering, the last instruction of a block B will have a lower number than the first instruction of any of B's successors, unless the successor is reached via a backwards edge that may be introduced by a loop.

Referring to FIG. 3, an instance of the graph of FIG. 2, drawn in the sorted node order, illustrates exemplary variable usage, for variables X, S, T, and Z. For each variable, the approach described below determines an interval from a first instruction to a last instruction (inclusive) according to the sequential numbering of blocks and within-block instructions described above that a variable is “live” and therefore must be allocated to a data item such that no other variable is assigned to that data item at any node in that interval. By “live” at an instruction we mean that a value of the variable held at the execution of that instruction may be subsequently used in execution of the program after execution of that instruction. Because that value can be used, the index by which that variable is referred to should not be used by some other variable at the time of execution of that instruction or else the value of the original value may be lost (e.g., overwritten).

In the simple example of FIG. 3 (which does not include any loops) numbering the instructions from I1 to I6, the variable X is active for the entire interval [I1,I6], Z is active for [I3,I6], S is active at [I2,I3] and T is active for the single node with instruction interval [I4,I5]. Basically, having determined these intervals, the allocation problem amounts to sorting the intervals according to the starting node, and progressing from the first to the last node allocating each variable to an available data item when an interval starts, and deallocating the data item (i.e., freeing the data item) at the end of the interval. The maximum number of data items needed is therefore the maximum number of overlapping intervals that include any node in the intermediate representation. In this simple example, the variables S and T could be mapped to a same memory index because their live intervals [I2,I3] and [I4,I5] do not overlap, but neither of those variable could share an index with variables X or Z, because they overlap the intervals [I1,I6] and [I3,I6}, respectively.

In the discussion and examples below, for ease of presentation, only a single instruction is shown in each block, and therefore blocks and instructions share the same numbering, recognizing that the procedures described are easily extended to multi-instruction blocks.

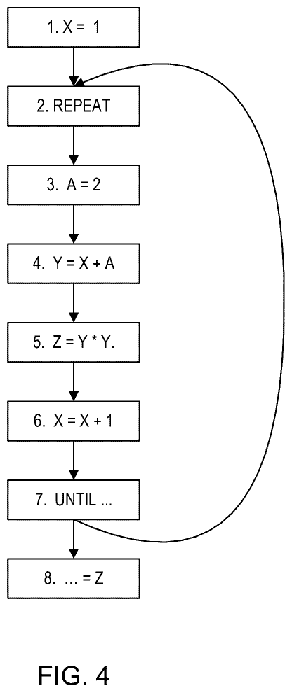

The illustrations of FIGS. 2-3 do not show any looping constructs. Referring to FIG. 4, an example of a graph representation of a “repeat” loop, with blocks listing skeletal instructions showing setting or use of variables X, Y, and Z. In such a loop, a block such as the “repeat” block is referred to as the “loop header” because it is the first block of the loop encountered in execution and flow of control re-enters the loop for subsequent iterations at that block. Based on visual inspection, it should be evident that the live interval of variable A is [3,4] because A is first set at node 3 and last used at node 4. On the other hand, X has an interval [1,7] because X is first set at node 1, and its value at block/instruction 7 may be needed later in execution, for example, in a flow for instructions such as 6, 7, 2, 3, 4. Variable Y has an interval [4,5] because it is set at node 4 and then used at node 5, but even when the transition from node 7 at the end of the loop back to node 2, the value of Y does not have to be retained because it will be over-written again at node 4. Variable Z has an interval [5,8] because it is first set at node 5, and last used at node 8. Again, even though Z is live (i.e., in use, active) at node 7, if the branch back to node 3 is taken, the value of Z does not have to be retained at node 3 or 4 because it will be the value of Z will be overwritten at node 5. Given these intervals, the interval of A and the interval of Z do not overlap and therefore these two variables may be assigned to the same data index.

Before specifying a procedure for determining the intervals of variables, it is useful to define a number of properties. The first is a “killing definition” (abbreviated as members of a set K), which is an instruction that assigns a variable in such a way that no history of its previous value is retained. For example, in the case of a variable being an array, merely setting one element of the array is not a “killing definition”, but zeroing the entire array, allocating new memory for the variable, and assigning a scalar variable a new value, are all examples of killing definitions. The other instructions that refer to the variable but are not killing definitions are referred to as “other references” (abbreviated as members of a set R) for the variable.

Another definition relates to loops. In the illustration of FIG. 4, the “repeat . . . until” loop has an interval [2,7] and as introduced above the first block 2 is referred to as the “header” block of the loop. Generally, a variable at a block in an interval of a loop is referred to as being “upwardly exposed” to the header block if the value of the variable must be retained in at least some execution path from the header block of the loop to that block, for example, because the value must be retained from a previous iteration of a loop. In the example of FIG. 4, the variable A is not upwardly exposed in the loop because it is set at block 3 (i.e., the instruction at block 3 is a killing definition) and therefore the value of A at block 2, for example, resulting from a transition from block 7 to block 2 in a previous iteration of the loop, cannot affect execution. On the other hand, the variable X is upwardly exposed because its value from a previous iteration may be (in this case is) needed for proper execution of the code. More precisely, a block (or an instruction in a block) is upwardly exposed to the header of a loop for a particular variable if there is at least one path in the graph of the intermediate representation from the header block (I) to that block that does not pass through any killing definition of the variable.

More particularly, for a loop header I and a set of killing definitions K and other references R for a variable, the procedures discussed below determine whether there is there is some path from I to any member of R (which trivially true if I dominates R) that doesn't go through any member of K. This dominance observation is important to the efficiency of the overall procedure because one does not need to actually search through the graph to find out whether there's a path, for example, requiring an expensive reachability matrix. Note also that, if that member of R is dominated by a member of K_{D}, any such path must go through a member of K.

As discussed further below, a general approach that is used in at least one implementation is that for any variable that is upwardly exposed to the header in a loop, the live interval from that variable includes at least the full interval of the loop. That is, the value of the variable must be maintained from the header node of the loop through its other reference, and must be retained from any reference (killing or other reference) through the end of the loop to be available in a subsequent iteration. But if a variable is not upwardly exposed, its live interval may be determined without consideration of the loop and the possible transition from the end of the loop back to the header of the loop.

In broad terms, the approach for determining the live interval of a variable begins with a first interval based on the first and last references found anywhere in the intermediate representation and numbered as described above without consideration of any loop structures in the graph. However, while the required interval for the variable must include that first interval, the required interval may be greater. Generally, the reason that the interval may be greater may arise from the use of that variable in loops. Over the process described above, the interval of a variable may be incrementally extended one or more times as a result of analysis of a loop structure of the intermediate representation.

Each loop has an interval starting at its header block (i.e., the first instruction of the header block) through the last instruction before possible return back to the header block. A first observation is that if the interval of a loop is entirely within a current live interval of a variable, that loop does not have to be considered as a basis of possible extension of the live interval of the variable. A second observation is that if the loop is outside the current live interval of the variable, it does not need to be considered because (unless the interval is extended later to include at least some of its interval) it cannot affect the live interval. A converse to these observation is that if the current live interval of a variable starts within the interval of a loop, or ends within an interval of a loop, then it is possible that the live interval of the variable must be extended to the full interval of the loop. While a conservative approach might be to simply extend the interval of any variable in any of the latter conditions, such an approach is not feasible, for example, in situation where a program that has an all-encompassing loop that essentially has an interval of the whole program, which would result in all variables having live interval of the entire program, thereby negating the value of performing a live interval analysis at all.

With the definitions provided above, a procedure (referred to as “Procedure 1”) for determining the live intervals for variables referenced in the blocks of an intermediate representation is as follows.

### Procedure 1

### Step 1

Order the instructions the intermediate representation in reverse post-order depth first. Number the instructions in each block to ensure that the last instruction in block B will have a lower number than the first instructions in any of B's successors, unless the successor is reached via a backwards edge (i.e., a transition back to a header node of a loop).

Also identify all the loops in the intermediate representation, and their associated intervals according to the number of the instructions.

### Step 2

The following steps 2A-2C are performed for each variable V:

### Step 2A

Collect a set of killing definitions (K) and other references (R) for the variable (V), each ordered by the instruction number.

### Step 2B

Determine an initial live interval for V as the interval from the first to the last member of either K or R.

### Step 2C

For each loop L in the intermediate representation perform the following two substeps:
STEP 2Ci: If L is contained entirely within V's interval, or if L contains no part of V's interval, ignore the loop L.
STEP 2Cii: Otherwise, check whether any member of R (whether in the loop or not) is upwardly exposed to the first instruction of L's header. If it is, expand V's interval to include all of L.

Note that at STEP 2B, there could be some member of R that appears before the first member of K, or some member of K that appears after the last member of R. In either case that would make the live interval larger than strictly necessary using the above procedure, however in practice such larger than necessary intervals are not significant. That is, the live interval determined by the procedure is not necessarily a minimal interval, but in practice it is a very useful interval for limiting the number of memory indices that are required for memory allocation based on the intermediate representation.

A significant aspect of the procedure listed above is the determination in step 2Cii of whether any reference in R is upwardly exposed to the first instruction of the header node of the loop L. In order to illustrate the significance of this step, it may be illuminating to consider a number of examples.

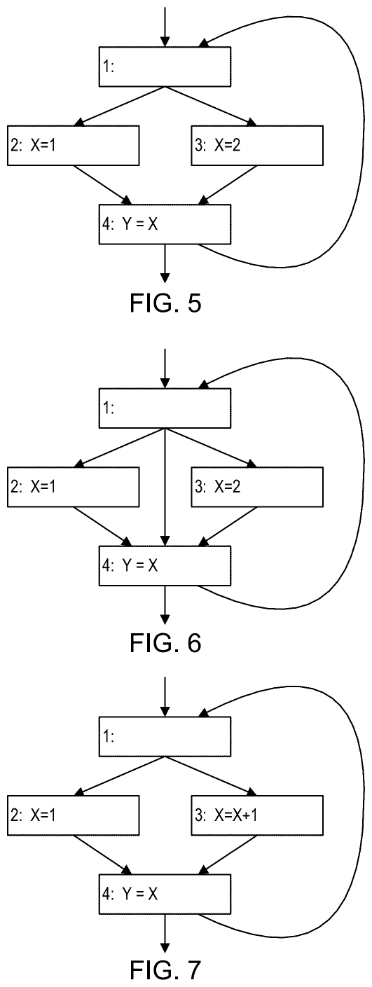

In FIG. 5, for a loop with a header block 1, the initial live interval for variable X is [2,4]. The killing definitions are K={2,3} and other references are R={4}. Because there is no path from block 1 to block 4 that does not go through a member of K, there is no expansion of the live interval of X necessitated by a loop.

On the other hand, referring to FIG. 6, which introduces a path from block 1 to block 4 that does not pass through K, block 4 is upwardly exposed to block 1, and therefore the live interval of X is expanded to include the entire interval [1,4] of the loop. This can be understood, for instance, by considering a first iteration of the loop passing via blocks 1→2→4, and a second iteration of the loop passing via blocks 1→4. The value of X (i.e., X=1) needs to be retained at block 1 so that it would be properly used in the assignment of Y at block 4.

A similar result comes in the example of FIG. 7 in which the initial live interval is [2,4], K={2} and R={3,4}. In this example, both blocks 3 and 4 are upwardly exposed to block 1, so the value of X at block 1 may be used at blocks 3 and 4, and therefore the live interval is extended to [1,4].

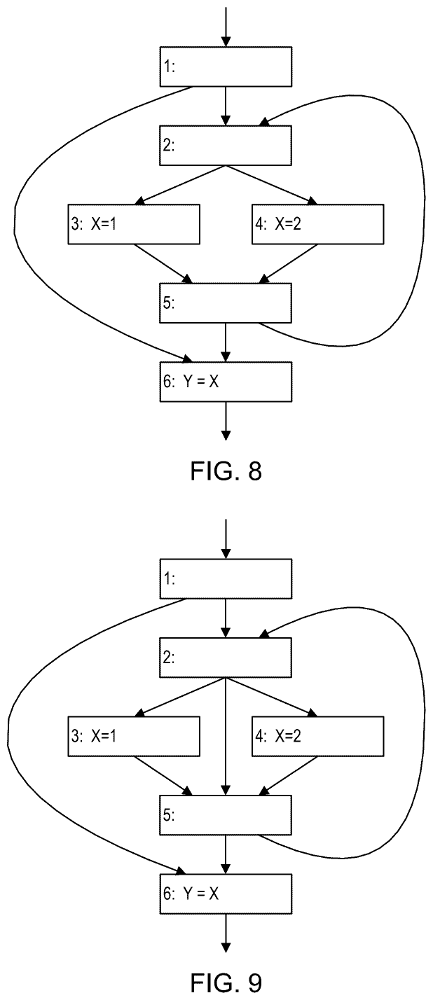

The search for any member of R that may be upwardly exposed to the loop header is not limited to blocks within a loop. In the example of FIG. 8, a loop L spans blocks [2,5], and the initial live interval for X is [3,6]. While there are killing definitions at blocks K={3,4}, there is no other reference in the loop, with R={6} in this example. The analysis of this example is similar to the example of FIG. 6 in that there is no path from the loop header block 2 to block 6 that does not pass through a member of K. So block 6 is not upwardly exposed to the loop header, and the live interval of X is not expanded to include the entire loop L.

Compare the example of FIG. 8 with the example of FIG. 9, in which there is a path from block 2 to block 5, in a similar arrangement as shown in FIG. 6. In this case, R={6} and instruction 6 is upwardly exposed to the loop header block 2. So the live interval of X is expanded from [3,6] to include [2,5], resulting in the new live interval for X being [2,6]. So it should be evident that consideration of other references must include at least some references that are outside the loop being considered.

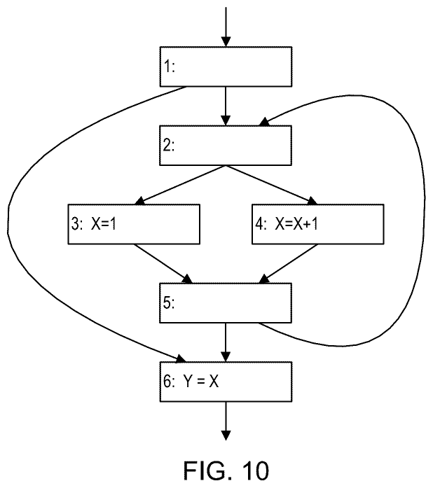

The example of FIG. 10 is analogous to the example of FIG. 7. Note that in this case, the other references are R={4,6}. Having determined that instruction 4 is upwardly exposed to the loop header block 2, then the live interval is expanded to be [2,6] and there is no need for further analysis of instructions such as instruction 6 because the live interval has already been expanded to include the entire loop interval [2,5]. So while any member of R may cause the loop interval to be expanded, once any one other reference is found that causes the interval to be expanded, there is no need to look further for this loop.

Therefore, a second procedure (referred to as “Procedure 2”) is used to efficiently determine whether there exists any other reference (i.e., member of R) that is upwardly exposed to the loop header block. An inefficient procedure might be to enumerate all the other references in R, and for each perform a graph search to determine if there is upward exposure from that block to the head of the loop, but it should be evident that such an approach has undesirable computational complexity.

Prior to specifying Procedure 2, it is useful to define a property of “dominance” of an instruction (v) by another instruction (u), denoted dom(u,v), as being true if every path from the start of the graph to v must necessarily go through u, with the possibility that u=v (i.e., an instruction dominates itself). Related to this definition is “strict dominance” which excludes an instruction dominating itself, denoted sdom(u,v) and equal to dom(u,v) AND u≠v. Note that NOT(sdom(u,v))=NOT(dom(u,v)) OR u=v.

A further definition that is useful is that of a set of blocks referred to as the “dominance frontier” of another block. In broad terms, a block y may be in the dominance frontier of another block x (denoted domf(x)) if it is not strictly dominated by x (i.e., either y is not dominated by x, or y=x). Furthermore, to be in the dominance frontier, there must be block p that is a predecessor of block y (i.e., a direct link from p to y) where p is itself dominated by x. So generally, a block is in the dominance frontier of x if it is not itself strictly dominated by x but it is directly linked from a block dominated by x. Furthermore, a block can be in its own dominance frontier (i.e., y=x) if it directly links to itself, or if some other block (p) dominated by it is directly linked to it.

Using this definition of dominance frontier, an efficient recursive procedure (“Procedure 2”) determines whether there is any other reference in R for a particular loop L and variable V by considering successive dominance frontiers until a reference in R is found that is upwardly exposed to the header of L, or it is certain that no such reference in R exists, in which case the interval of L does not have to be added to the live interval of V.

Because the definition of the procedure is recursive, we define it in terms of arguments V and I, such that the procedure is started as Procedure2(I=loop header of L, V), with static sets R and K for the variable V being accessible to the procedure.

### Procedure 2 (I, V)

### Step 1

Of the killing definitions of variable V, denoted K, determine a subset denoted K_{D} as consisting of the members of K that are dominated by I. That is, for any block k in K_{D}, all paths from the entry block to k go through I.

### Step 2

Expand K_{D} to iteratively include the first instruction of any basic block B that is dominated by I, and not dominated by any member of K_{D}, but all of whose predecessors are dominated by members of K_{D}.

Step 3: Determine the members of the other references, denoted R, of variable V that are dominated by I, and not dominated by a member of K_{D}.

### Step 4

If there is any such member of R in step 3,

### Step 4A

then: there is a block that is upwardly exposed to I, and in turn is also upwardly exposed to the loop header (see STEP 2Cii in Procedure 1 above) and the interval of the loop must be added to the live interval of variable V, and all further search of R can be terminated;

### Step 4B

otherwise (i.e., there is no member of R that is found in step 3): for each block F in the dominance frontier of I (domf(I)) with an incoming link from a block that is dominated by I and not dominated by any member of K_{D}, perform Procedure2(F, V). That is, the point of this recursive call is to determine if there is a path from I to any member of R that is not dominated by I.

Returning to the examples of FIGS. 5-10, application of Procedure 1 and Procedure 2 is described in detail below with regard to a variable X. Starting with FIG. 5, at Procedure 1, Step 2A, the set of killing definitions of X is {2,3} and the sets of other references of R is {4}. The initial live interval of X is then step at Step 2B as [2,4]. Because the loop interval [1,4] is not entirely contained within the live interval of X (Step 2C), we proceed to step 2Cii, which is evaluated as Procedure2 (V=X, I=1). At Procedure 2, Step 1, K_{D} is determined to be {2,3}, and then at Step 2, K_{D} is expanded to include block 4 because while no one block in K_{D} dominates block 4, all block 4's predecessors are dominated by a member of K_{D}, in this case satisfied because each of block 4's predecessors are themselves in K_{D} (recalling as discussed above, by definition a block dominates itself). At Step 3, block 4 (the only member of R) is determined to be dominated by block 1, but it is also dominated by a member of K_{D} (i.e., itself) so it is not upwardly exposed. Therefore, proceeding to Step 4B, we consider the dominance frontier of block 1, which in this case is empty, and the procedure terminates without adding the loop interval [1,4] to the live interval of variable X.

The execution of the procedures for the example of FIG. 6 is similar. However, at Procedure 2, Step 2, block 4 is not added to K_{D} because one of the predecessors of block 4, namely block 1, is not dominated by the members of K_{D}. At Procedure 2, Step 3, block 4 (a member of R) is determined to be dominated by block 1, and is not dominated by a member of K_{D} (i.e., it is neither dominated by block 2 nor block 3). So at Step 4A it is determined that block 4 is upwardly exposed to block 1, and the loop interval [1,4] is added to the live interval of variable X.

In the example of FIG. 7, initially K={2} and R={3,4} and Procedure 2 is executed with I=1. K_{D} remains {2} without expansion in Step 2, and at Step 3, blocks 3 and 4 are identified as being dominated by 1 and not dominated by 2. Since there are such blocks at Step 4A, the live interval of X is expanded to include the loop interval [1,4].

In the example of FIG. 8, K_{D} initially is set of {3,4} and R to {6}. Block 5 gets added to K_{D} because all of its incoming links are dominated by a block in K_{D} (i.e., block 5 has incoming links from blocks 3 and 4, each of which are in K_{D}). But the loop header (I=2) does not dominate any block in R (i.e., block 6, which is accessible from block 1 without traversing block 2). So Procedure 2, Step 4B is performed, in which the dominance frontier of block 2 (domf(2)) is determined to be {6}. Block 6 has two incoming links: block 1 is not dominated by block 2, so the link from it is ignored; block 5 is dominated by block 2, but is also dominated by a member of K_{D}, so Procedure 2 is not recursively performed.

In the example of FIG. 9, in the top-level execution of Procedure 2 with I=2, K_{D} is set at Step 1 to {3,4} and not expanded at Step 2. Because at Step 3, it is determined that block 5 is not dominated by block 3, the dominance frontier is considered at Step 4B, and block 6 is determined to be upwardly exposed to the dominance frontier (i.e., upwardly exposed to itself). Therefore block 6 is also upwardly exposed to block 2.

The example of FIG. 10 begins with K={3} and R={4,6}. Procedure 2 is invoked with I=2, and K_{D} is set to {3} at Step 2 and not expanded at Step 3. Because block 4 in R is dominated by block 2, and not dominated by block 3, the loop interval [2,5] is added to the live interval of X without any recursive execution of Procedure 2.

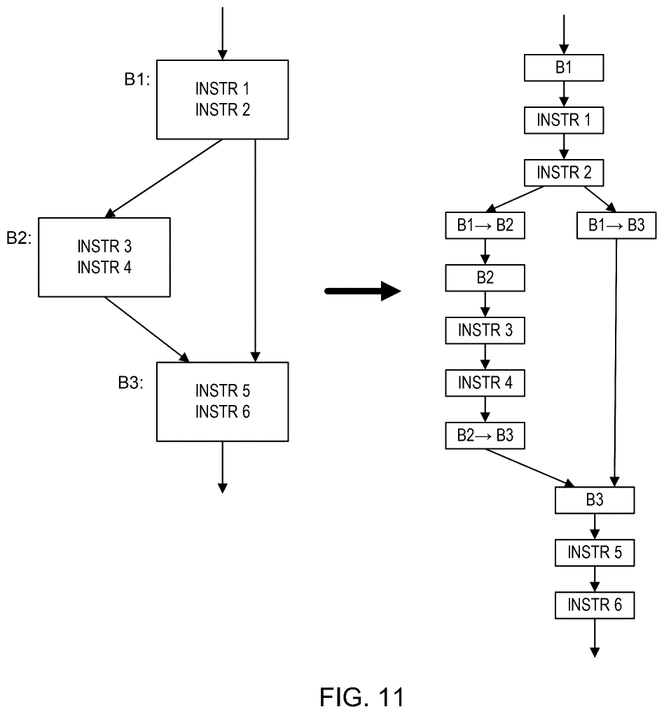

Turning back to the distinction of blocks and instructions, a control flow graph (CFG) can be expanded into a CFG where each block has either exactly one instruction, or indicates the entry into an original block, or indicates a transition between blocks, with the expanded graph being numbered in reverse post-order as discussed above. An example of such an expansion is shown in FIG. 11 with an original graph on the left, and the corresponding expanded graph on the right. The procedures described above may be applied to such an expanded graph to determine the live interval of each variable in the same way that it can be applied to basic blocks containing multiple instructions without any internal branching.

As introduced above, having determined the live interval of each variable, for example for each named variable (i.e., named by a character string) is assigned to one of the limited number of memory indices in a many-to-one mapping such that, in general, there may be multiple named variables that map to the same memory index such that the live intervals of the variables do not overlap and therefore execution of the program remains correct in the sense that memory values are not incorrectly overwritten.

As introduced above, the assignment of named variables to memory indices enables a translation of an intermediate instruction such as x [j]=y or SET x, j, y (a SET instruction with operands x, j, and y) to a virtual machine instruction where the operands are replaced with their respective memory indices. In general, this replacement is performed in Code Generation stage 126 of compilation 120 as illustrated in FIG. 1, which may result in the virtual machine instructions 130 being stored in a persistent memory for later execution, or held in a volatile memory in the case of a just-in-time compilation. One way of implementing a virtual machine to execute instructions that include the memory indices is for the virtual machine to maintain a storage area with distinct descriptive sections being accessible according to respective memory indices (e.g., if the storage area has a series of fixed-size section), and these descriptive sections provide further information about the structure of the variable (e.g., its size, arrangement, etc.) and reference to the underlying storage locations for the data of the variable. Maintenance of the storage for the descriptive sections and the underlying data storage for the variable is performed by the virtual machine and/or by underlying memory management services of the host software environment (e.g., operating system) under which the virtual machine executes.

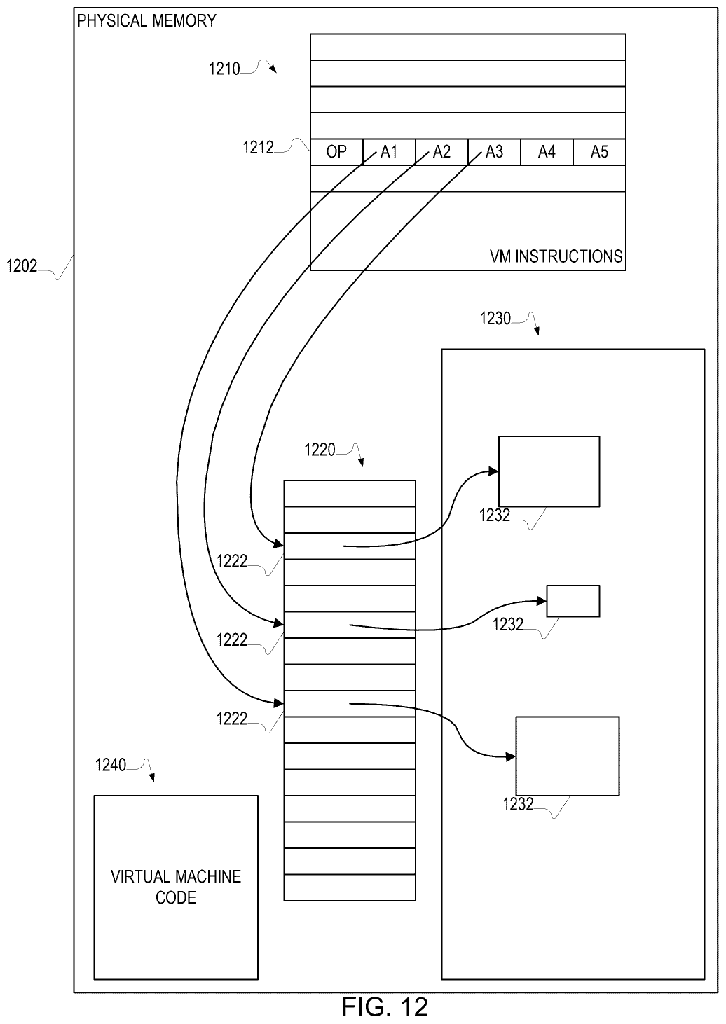

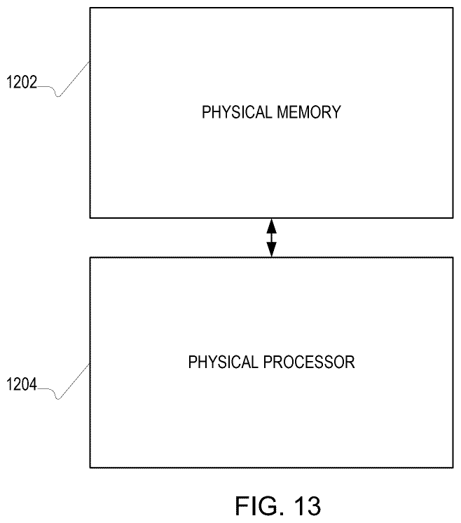

Referring to FIG. 12, an example of an arrangement of physical memory 1202, which is accessed by a physical processor 1204 as shown in FIG. 13, includes are number of memory areas. A memory area 1240 holds the instructions that are executed by the processor to implement the virtual machine. The instructions for execution by the virtual machine are held in a memory area 1210, including a representative instruction 1212. This representative instruction is shown to have an operation code section, and a number of argument sections. As discussed above, each of these argument sections includes an index to a memory item, for example, having K bits allocated to each argument, such that at most 2^{K}memory items may be referenced. A memory area 1220 holds descriptive data segments 1222, with one segment for each data item that may be referenced by instructions 1212. That is, there may be a limit of 2^{K} such descriptive data segments. A memory area 1230 holds the data for each for the data items, shown as segments 1232, illustrating that each data segment 1232 may be of a different type of size.

While in some implementations, the compilation 120 of FIG. 1 is hosted in the same computation environment as the execution 140, for example, because a just-in-time compilation approach is performed, these steps may be performed in different computation environments, with the instructions 130 being transferred from the computation environment to the runtime execution environment.

The compilation steps described above (e.g., Procedure 1 and Procedure 2) may be implemented in software using instructions stored on non-transitory machine-readable media. These instructions, when executed by a processor of a data processing system to perform the steps described above. The instructions may be high-level language instructions, intermediate (e.g., assembly language) instructions, or compiled machine level or intermediate level representations. The machine instructions may be for execution by a physical processor (e.g., a central processing unit (CPU)) or may be executed by a virtual machine. Other forms of the instructions may be interpreted by a software-implemented interpreter without necessarily being compiled into an intermediate representation or machine-level representation.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for executing a program specification on a processor, including allocating a first set of distinct variables in a first representation of the program specification to a second set of memory items accessible by the processor, wherein the number of memory items in the second set is smaller than the number of distinct variables in the first set, and the number of memory items in the second set is limited by a memory characteristic of the processor, and wherein the first representation of the program specification comprises a graph in which nodes of the graph specify instructions referencing the variables, and directed links coupling nodes of the graph represent allowable paths of control flow during execution of the program specification, the method comprising:
determining an enumerated ordering of the nodes of the graph representation, such that each node has a unique number;
identifying all loops represented in the graph, each loop having a set of nodes that are linked as part of a cycle by directed links of the graph, and having an interval of the lowest to the highest number of the nodes in the set of nodes in each loop;
determining a live interval for each distinct variable in the first representation of the program specification;
wherein determining a live interval for a first variable of the distinct variables comprises:
determining a first subset of nodes in the graph of nodes that specify an instructions referencing the first variable, determining a second subset of nodes in which the instruction specified by said nodes fully assign the first variable, and determining a third subset of nodes consisting of the nodes in the first set of nodes that are not in the second set of nodes;
initializing a live interval for the first variable as an interval from the lowest numbered node to the highest numbered node in the first subset of nodes; and
expanding the live interval for the first variable according to one or more loops represented in the graph, including expanding the live interval for the first variable according to a first loop represented in the graph including:
determining an interval of the first loop as the interval from the lowest numbered node of the first loop to the highest numbered node of the first loop, the loop having a header node being a first node of the first loop accessed during execution of the program specification;
determining if there is any node in the third subset of nodes for which there is at least one path of execution from the header node of the first loop that does not pass through a node in the second subset of nodes;
having determined that there is a node in the third subset of nodes, expanding the live interval of the first variable to include the full interval of nodes of the first loop;
allocating variables of the first set of distinct variables to memory items of the second set of memory items, including allocating multiple of said variables to a same memory item according to the live intervals for said multiple variables; and
forming a second representation of the program specification using a result of allocating the variables.

2. The method of claim 1, further comprising providing the second representation of the program specification for execution using the processor to access the memory items during execution according to the allocation of variables to the memory items.

3. The method of claim 1 wherein determining the enumerated ordering of the nodes of the graph representation includes forming a depth-first ordering based on the directed links coupling the nodes of the graph.

4. The method of claim 1 further comprising forming the program specification from an initial program specification that comprises a graph-based program specification.

5. The method of claim 1, wherein the processor comprises a virtual processor executing on a physical processor, and wherein the second set of memory items accessible by the processor comprises a data structure accessible to the physical processor with a distinct storage area accessible by the virtual processor for each memory item, wherein execution of a first instruction of the second representation of the program specification by the virtual processor comprises the physical processor accessing a storage item in the data structure corresponding to a memory item in a field of the first instruction.

6. The method of claim 5 wherein at least some of the distinct storage items includes references to data storage areas accessible to the physical processor outside the data structure.

7. The method of claim 1 wherein the number of memory items in the second set exceeds 1023 memory items.

8. The method of claim 7 wherein the number of memory items in the second set exceeds 16383 memory items.

9. The method of claim 1 wherein determining if there is any node in the third subset of nodes for which there is at least one path of execution from the header node of the first loop that does not pass through a node in the second subset of nodes comprises determining that there is such a node that can be reached only via the header node.

10. The method of claim 1 wherein determining if there is any node in the third subset of nodes for which there is at least one path of execution from the header node of the loop that does not pass through a node in the second subset of nodes comprises
determining that there is no such a node that can be reached only via the header node,
forming a fourth subset of nodes that is distinct from the third subset of nodes and that can be reached in an execution path from the header node without passing through a node of the second subset and can further be reached in an execution path without passing through the header node, and
determining if there is any node in the third subset of nodes for which there is at least one path of execution from a node in the fourth subset that does not pass through a node in the second subset of nodes.

11. The method of claim 1 comprising determining live intervals for variables referenced in blocks of the first representation including
ordering instructions the first representation in reverse post-order depth-first order, numbering the instructions in each block such that the last instruction in a block B has a lower number than the first instructions in any of B's successors, unless the successor is reached via a backwards link, and identifying all the loops in the first representation and their associated intervals according to the number of the instructions;
performing for each variable V of the variables references in the blocks,
collecting a set of killing definitions (K) and other references (R) for the variable (V), each ordered by an instruction number,
determining an initial live interval for variable V as the interval from the first to the last member of either K or R,
for each loop L in the first representation,
if L is contained entirely within V's interval, or if L contains no part of V's interval, ignore the loop L,
otherwise, check whether any member of R is upwardly exposed to the first instruction of L's header,
if the member of R is upwardly exposed, expand V's interval to include all of L.

12. The method of claim 11 comprising a recursive procedure to determine whether there is any other reference in R for a particular a loop L and a variable V by considering successive dominance frontiers until a reference in R is found that is upwardly exposed to the header of L, or it is certain that no such reference in R exists, in which case the interval of L does not have to be added to the live interval of V, said procedure being defined in terms of arguments V and I, such that the procedure is started with I being the loop header of L and with static sets R and K for the variable V being accessible to the procedure, the recursive procedure comprising:
of killing definitions of variable V, denoted K, determine a subset denoted KD as consisting of the members of K that are dominated by I;
expand KD to iteratively include the first instruction of any basic block B that is dominated by I, and not dominated by any member of KD, but all of whose predecessors are dominated by members of KD;
determine the members of the other references, denoted R, of variable V that are dominated by I, and not dominated by a member of KD,
if there is any member of R that is dominated by I, and not dominated by a member of KD, the interval of the loop is added to the live interval of variable V, and all further searches of R are terminated,
otherwise for each block F in the dominance frontier of I with an incoming link from a block that is dominated by I and not dominated by any member of KD, perform perform the recursive procedure with arguments F and V.

13. The method of claim 1, further comprising executing the second representation of the program specification using the processor, including accessing the memory items during execution according to the allocation of variables to the memory items.

14. The method of claim 13, further comprising:
forming the program specification from an initial program specification that comprises a graph-based program specification; and
wherein the number of memory items in the second set exceeds 16383 memory items the processor comprises a virtual processor executing on a physical processor, and wherein the second set of memory items accessible by the processor comprises a data structure accessible to the physical processor with a distinct storage area accessible by the virtual processor for each memory item, wherein execution of a first instruction of the second representation of the program specification by the virtual processor comprises the physical processor accessing a storage item in the data structure corresponding to a memory item in a field of the first instruction.

15. The method of claim 14, further comprising determining live intervals for variables referenced in blocks of the first representation including
ordering instructions the first representation in reverse post-order depth-first order, numbering the instructions in each block such that the last instruction in a block B has a lower number than the first instructions in any of B's successors, unless the successor is reached via a backwards link, and identifying all the loops in the first representation and their associated intervals according to the number of the instructions;
performing for each variable V of the variables references in the blocks,
collecting a set of killing definitions (K) and other references (R) for the variable (V), each ordered by an instruction number,
determining an initial live interval for variable V as the interval from the first to the last member of either K or R,
for each loop L in the first representation,
if L is contained entirely within V's interval, or if L contains no part of V's interval, ignore the loop L,
otherwise, check whether any member of R is upwardly exposed to the first instruction of L's header,
if the member of R is upwardly exposed, expand V's interval to include all of L.

16. The method of claim 15 comprising a recursive procedure to determine whether there is any other reference in R for a particular a loop L and a variable V by considering successive dominance frontiers until a reference in R is found that is upwardly exposed to the header of L, or it is certain that no such reference in R exists, in which case the interval of L does not have to be added to the live interval of V, said procedure being defined in terms of arguments V and I, such that the procedure is started with I being the loop header of L and with static sets R and K for the variable V being accessible to the procedure, the recursive procedure comprising:
of killing definitions of variable V, denoted K, determine a subset denoted KD as consisting of the members of K that are dominated by I;
expand KD to iteratively include the first instruction of any basic block B that is dominated by I, and not dominated by any member of KD, but all of whose predecessors are dominated by members of KD;
determine the members of the other references, denoted R, of variable V that are dominated by I, and not dominated by a member of KD,
if there is any member of R that is dominated by I, and not dominated by a member of KD, the interval of the loop is added to the live interval of variable V, and all further searches of R are terminated,
otherwise for each block F in the dominance frontier of I with an incoming link from a block that is dominated by I and not dominated by any member of KD, perform perform the recursive procedure with arguments F and V.

17. A non-transitory machine-readable medium comprising instructions stored thereon that when executed by a processor of a data processing system cause said system to perform operations for allocating a first set of distinct variables in a first representation of the program specification to a second set of memory items accessible by the processor, wherein the number of memory items in the second set is smaller than the number of distinct variables in the first set, and the number of memory items in the second set is limited by a memory characteristic of the processor, and wherein the first representation of the program specification comprises a graph in which nodes of the graph specify instructions referencing the variables, and directed links coupling nodes of the graph represent allowable paths of control flow during execution of the program specification, the operations including:
determining an enumerated ordering of the nodes of the graph representation, such that each node has a unique number;
identifying all loops represented in the graph, each loop having a set of nodes that are linked as part of a cycle by directed links of the graph, and having an interval of the lowest to the highest number of the nodes in the set of nodes in each loop;
determining a live interval for each distinct variable in the first representation of the program specification;
wherein determining a live interval for a first variable of the distinct variables comprises:
determining a first subset of nodes in the graph of nodes that specify an instructions referencing the first variable, determining a second subset of nodes in which the instruction specified by said nodes fully assign the first variable, and determining a third subset of nodes consisting of the nodes in the first set of nodes that are not in the second set of nodes;
initializing a live interval for the first variable as an interval from the lowest numbered node to the highest numbered node in the first subset of nodes; and
expanding the live interval for the first variable according to one or more loops represented in the graph, including expanding the live interval for the first variable according to a first loop represented in the graph including:
determining an interval of the first loop as the interval from the lowest numbered node of the first loop to the highest numbered node of the first loop, the loop having a header node being a first node of the first loop accessed during execution of the program specification;
determining if there is any node in the third subset of nodes for which there is at least one path of execution from the header node of the first loop that does not pass through a node in the second subset of nodes;
having determined that there is a node in the third subset of nodes, expanding the live interval of the first variable to include the full interval of nodes of the first loop;
allocating variables of the first set of distinct variables to memory items of the second set of memory items, including allocating multiple of said variables to a same memory item according to the live intervals for said multiple variables; and
forming a second representation of the program specification using a result of allocating the variables.

18. A data processing system comprising:
a compilation system, comprising a processor and instructions stored on non-transitory machine-readable medium for executing on the processor, the instructions when executed on the processor perform operations for allocating a first set of distinct variables in a first representation of a program specification to a second set of memory items accessible by the processor, wherein the number of memory items in the second set is smaller than the number of distinct variables in the first set, and the number of memory items in the second set is limited by a memory characteristic of the processor, and wherein the first representation of the program specification comprises a graph in which nodes of the graph specify instructions referencing the variables, and directed links coupling nodes of the graph represent allowable paths of control flow during execution of the program specification, the operations including:
determining an enumerated ordering of the nodes of the graph representation, such that each node has a unique number;
identifying all loops represented in the graph, each loop having a set of nodes that are linked as part of a cycle by directed links of the graph, and having an interval of the lowest to the highest number of the nodes in the set of nodes in each loop;
determining a live interval for each distinct variable in the first representation of the program specification;
wherein determining a live interval for a first variable of the distinct variables comprises:
determining a first subset of nodes in the graph of nodes that specify an instructions referencing the first variable, determining a second subset of nodes in which the instruction specified by said nodes fully assign the first variable, and determining a third subset of nodes consisting of the nodes in the first set of nodes that are not in the second set of nodes;
initializing a live interval for the first variable as an interval from the lowest numbered node to the highest numbered node in the first subset of nodes; and
expanding the live interval for the first variable according to one or more loops represented in the graph, including expanding the live interval for the first variable according to a first loop represented in the graph including:
determining an interval of the first loop as the interval from the lowest numbered node of the first loop to the highest numbered node of the first loop, the loop having a header node being a first node of the first loop accessed during execution of the program specification;
determining if there is any node in the third subset of nodes for which there is at least one path of execution from the header node of the first loop that does not pass through a node in the second subset of nodes;
having determined that there is a node in the third subset of nodes, expanding the live interval of the first variable to include the full interval of nodes of the first loop;
allocating variables of the first set of distinct variables to memory items of the second set of memory items, including allocating multiple of said variables to a same memory item according to the live intervals for said multiple variables; and
forming a second representation of the program specification using a result of allocating the variables; and
a runtime system for executing the second program specification, said system comprising a processor and a memory, the memory comprising:
storage for the second representation of the program specification;
storage for the second set of memory item; and
storage for instructions for implementing the processor, said instructions including instruction for processing the second representation of the program specific and accessing memory items of the second set of memory items according to said second representation of the program specification.
